(19) United States
(12) Patent Application Publication
(10) Pub. No.: US 2016/0204976 A1
(43) Pub. Date: Jul. 14, 2016

(54) IDENTIFYING THE ABSENCE AND PRESENCE OF A RING PROTECTION LINK OWNER NODE IN AN ETHERNET NETWORK

(71) Applicants: Rajnath Singh, Murphy, TX (US); Farid Khalilzadeh, Allen, TX (US); Swati Mittal, Murphy, TX (US); Daniel Cao, Allen, TX (US); Si Long Ho, Allen, TX (US)

(72) Inventors: Rajnath Singh, Murphy, TX (US); Farid Khalilzadeh, Allen, TX (US); Swati Mittal, Murphy, TX (US); Daniel Cao, Allen, TX (US); Si Long Ho, Allen, TX (US)

(21) Appl. No.: 14/596,795

(22) Filed: Jan. 14, 2015

(51) Int. Cl. H04L 12/24; H04L 12/26

(52) U.S. Cl. CPC H04L 41/0654; H04L 43/06; H04L 43/50

(57) ABSTRACT

A method and system for identifying the absence and presence of a ring protection link in Ethernet networks are disclosed. The method may include sending, by a node in a ring of an Ethernet network having a plurality of nodes and an RPL, an APS message. The method may further include receiving, by the node via the ring, the APS message and determining whether the node is an RPL owner node that controls the flow of traffic on the RPL. The method may further include, raising, when it is determined that the node is not an RPL owner node, an alarm indicating that the ring lacks a provisioned RPL owner node.

### BACKGROUND

1. Field of the Disclosure

The present disclosure relates to communications systems and more specifically to identifying the absence and presence of a ring protection link in Ethernet networks.

2. Description of the Related Art

A communication network may include network elements that route packets through the network. The communication network may be an Ethernet network.

In the G.8032 Recommendation promulgated by the International Telecommunication Union Telecommunication Standardization Sector (ITU-T), Ethernet ring network protection switching (ERPS) is described with the aim of fast protection switching for ring topologies having physical loops while ostensibly avoiding logical loops at the Ethernet layer. Logical loops adversely affect network performance and operation and are undesirable for Ethernet networks. Specifically, G.8032 avoids logical loops in an Ethernet ring network by reserving so-called Ring Protection Links (RPL), which are linked to an RPL Owner Node and an RPL Neighbor Node at each end of the ring. When the Ethernet ring network is operating normally, the RPL blocks network traffic to avoid logical loops from forming. When an associated physical link in the Ethernet ring network fails, the RPL is activated to transmit (e.g., unblock) network traffic by the RPL Owner Node or the RPL Neighbor Node.

However, despite the G.8032 protocol, configurations of Ethernet ring networks designed to have a designated RPL may still lack an RPL or may lack the ability to detect the presence of duplicate RPL Owner Nodes, which is undesirable.

### SUMMARY

In one aspect, a disclosed method for identifying a ring protection link (RPL) owner node in an Ethernet network may include sending, by a node in a ring of an Ethernet network having a plurality of nodes and an RPL, an automatic protection switching (APS) message. The method may further include receiving, by the node via the ring, the APS message. The method may further include determining whether the node is an RPL owner node that controls the flow of traffic on the RPL. When the node is not an RPL owner node, the method may further include raising an alarm indicating that the ring lacks a provisioned RPL owner node.

In another embodiment, a method for identifying an RPL owner node in an Ethernet network may include provisioning one of a plurality of nodes as an RPL owner node. The method may further include sending, by the RPL owner node, an APS message with an RPL owner bit set to 1. The method may further include counting a number of nodes sending APS messages with the RPL owner bit set to 1. The method may further include determining whether the number of nodes sending APS messages with the RPL owner bit set to 1 is greater than one. The method may further include raising when it is determined that the number of nodes sending APS messages with the RPL owner bit set to 1 is greater than 1, an alarm indicating that multiple RPL owner nodes are provisioned

In another embodiment, a system for identifying logical loops in an Ethernet network is provided. The system may include a processor configured to access non-transitory computer readable memory media. The memory media may store processor-executable instructions where the instructions, when executed by a processor, cause the processor to send, by a node in a ring of an Ethernet network having a plurality of nodes and an RPL, an APS message; receive, by the node via the ring, the APS message; determine whether the node is an RPL owner node that controls the flow of traffic on the RPL; and raise when it is determined that the node is not an RPL owner node, an alarm indicating that the ring lacks a provisioned RPL owner node.

In another embodiment, a system for identifying logical loops in an Ethernet network is provided. The system may include a processor configured to access non-transitory computer readable memory media. The memory media may store processor-executable instructions where the instructions, when executed by a processor, cause the processor to provision one of a plurality of nodes as an RPL owner node; send, by the RPL owner node, a APS message with an RPL owner bit set to 1; count a number of nodes sending APS messages with the RPL owner bit set to 1; determine whether the number of nodes sending APS messages with the RPL owner bit set to 1 is greater than one; and raise when it is determined that the number of nodes sending APS messages with the RPL owner bit set to 1 is greater than 1, an alarm indicating that multiple RPL owner nodes are provisioned.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a block diagram showing selected elements of an embodiment of a network;

FIG. 2 illustrates a block diagram of selected elements of an embodiment of a control plane for implementing control plane functionality in networks;

FIG. 3 illustrates a flow chart of an example method for identifying the lack of a provisioned RPL owner node in a G.8032 network ring; and

FIG. 4 illustrates a flow chart of an example method for identifying the presence of multiple RPL owner nodes in a G.8032 network ring.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

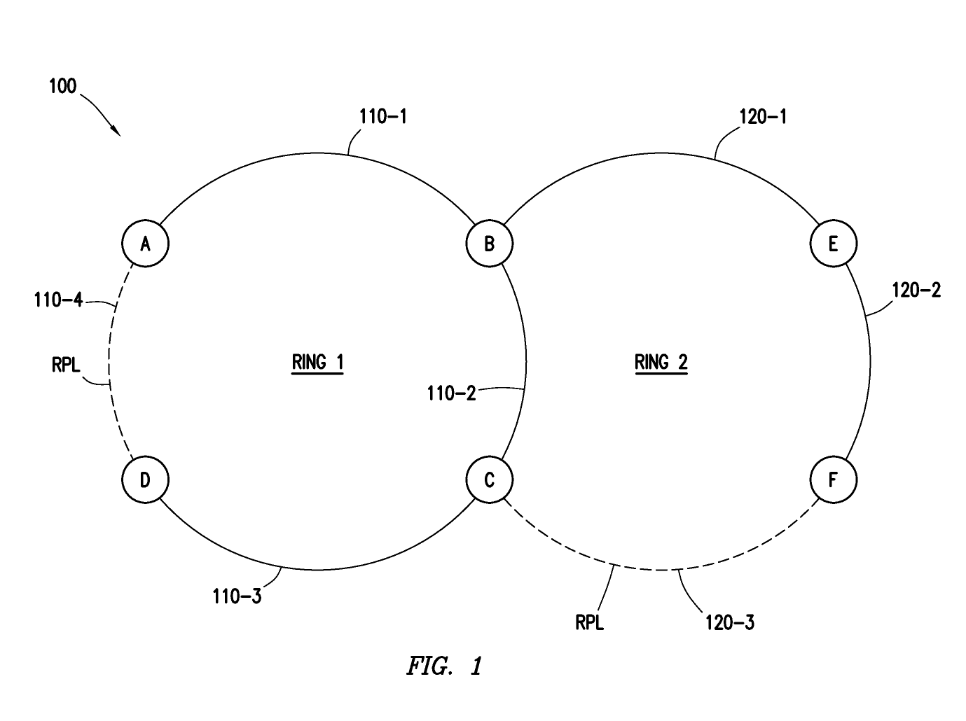

FIG. 1 illustrates a block diagram showing selected elements of an embodiment of network 100. In various embodiments, network 100 may be an Ethernet network. Network 100 may include one or more transmission links 110 and/or 120 operable to transport one or more signals communicated by components of network 100. The components of network 100, coupled together by transmission links 110 and/or 120, may include a plurality of network nodes A-F. In the illustrated network 100, each network nodes A-F is coupled to two other nodes. However, any suitable configuration of any suitable number of network nodes A-F may create network 100. Although network 100 is shown as a ring network, network 100 may also be configured as a ladder network, a point-to-point network, or any other suitable network or combination of networks. Network 100 may be used in a short-haul metropolitan network, a long-haul inter-city network, or any other suitable network or combination of networks.

Each transmission link 110 and/or 120 may include any system, device, or apparatus configured to communicatively couple network nodes A-F to each other and communicate information between corresponding network nodes A-F. For example, a transmission link 110 and/or 120 may include an optical fiber, an Ethernet cable, a T1 cable, a WiFi signal, a Bluetooth signal, and/or other suitable medium.

Network 100 may communicate information or “traffic” over transmission links 110 and/or 120. As used herein, “traffic” means information transmitted, stored, or sorted in network 100. Such traffic may comprise optical or electrical signals configured to encode audio, video, textual, and/or any other suitable data. The data may also be transmitted in a synchronous or asynchronous manner, and may be transmitted deterministically (also referred to as ‘real-time’) and/or stochastically. Traffic may be communicated via any suitable communications protocol, including, without limitation, the Open Systems Interconnection (OSI) standard and Internet Protocol (IP). Additionally, the traffic communicated via network 100 may be structured in any appropriate manner including, but not limited to, being structured in frames, packets, or an unstructured bit stream.

Each network node A-F in network 100 may comprise any suitable system operable to transmit and receive traffic. In the illustrated embodiment, each network node A-F may be operable to transmit traffic directly to one or more other network node A-F and receive traffic directly from the one or more other network node A-F.

Network 100 may include one or more rings designed in accordance with the G.8032 Recommendation. Each ring may include a ring protection link (RPL) (e.g., link 110-4 and link 120-3). The RPLs are redundant links that form a physical loop but are blocked according to G.8032 to prevent a logical loop from forming. According to the G.8032 Recommendation, each ring should have one and only one RPL provisioned. During operation or design of network 100, or a particular topology associated with network 100, certain criteria, detailed herein, may be applied to identify whether an RPL owner node has been provisioned. Additionally, certain criteria, detailed herein, may be applied to identify whether multiple RPL owner nodes exist in a ring of network 100.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

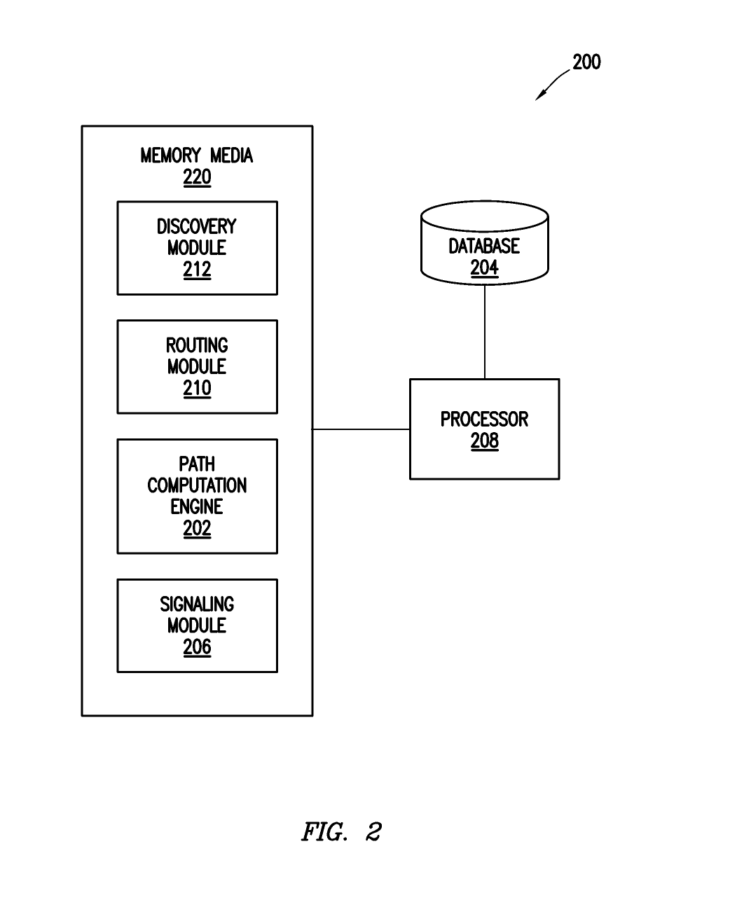

FIG. 2 illustrates a block diagram of selected elements of an embodiment of control plane 200 for implementing control plane functionality in networks, such as, for example, in network 100, as described with respect to FIG. 1. A control plane may include functionality for network intelligence and control and may include applications that support the ability to establish network services, including applications or modules for discovery, routing, path computation, and signaling, as will be described in further detail. The control plane applications executed by control plane 200 may work together to automatically establish services within network 100, which may be at least in part an optical network. Discovery module 212 may discover local links connecting to neighbors. Routing module 210 may broadcast local link information to network nodes while populating database 204. When a request for service from network 100 is received, path computation engine 202 may be called to compute a network path using database 204. This network path may then be provided to signaling module 206 to establish the requested service. Control plane 200 may be implemented in any suitable manner and at any suitable location, such as by a network management system located at a centralized server or a personal computer or distributed throughout the nodes. Based on the health of the links, control plane 200 may decide to block or unblock links in the network.

As shown in FIG. 2, control plane 200 includes processor 208 and memory media 220, which store executable instructions (e.g., executable code) executable by processor 208, which has access to memory media 220. Processor 208 may execute instructions that cause control plane 200 to perform the functions and operations described herein. For the purposes of this disclosure, memory media 220 may include non-transitory computer-readable media that stores data and/or instructions for at least a period of time. Memory media 220 may comprise persistent and volatile media, fixed and removable media, and magnetic and semiconductor media. Memory media 220 may include, without limitation, storage media such as a direct access storage device (e.g., a hard disk drive or floppy disk), a sequential access storage device (e.g., a tape disk drive), compact disk (CD), random access memory (RAM), read-only memory (ROM), CD-ROM, digital versatile disc (DVD), electrically erasable programmable read-only memory (EEPROM), and/or flash memory; non-transitory media; and/or various combinations of the foregoing. Memory media 220 is operable to store instructions, data, or both. Memory media 220 as shown includes sets or sequences of instructions that may represent executable computer programs, namely, path computation engine 202, signaling module 206, discovery module 212, and routing module 210. In some embodiments, path computation engine 202, in conjunction with signaling module 206, discovery module 212, and/or routing module 210, may represent instructions and/or code for implementing various algorithms according to the present disclosure.

In certain embodiments, control plane 200 may be configured to interface with a person (e.g., a network administrator) and receive data about the signal transmission path. For example, control plane 200 may also include and/or may be coupled to one or more input devices and/or output devices to facilitate receiving data about the signal transmission path from the network administrator and/or outputting results to the network administrator. The one or more input and/or output devices (not expressly shown) may include, but are not limited to, a keyboard, a mouse, a touchpad, a microphone, a display, a touchscreen display, an audio speaker, or the like. Alternately or additionally, control plane 200 may be configured to receive data about the signal transmission path from a device such as another computing device and/or a network element (not expressly shown).

In some embodiments, discovery module 212 may be configured to receive data concerning a signal transmission path in a network and may be responsible for discovery of neighbors and links between neighbors. In other words, discovery module 212 may send discovery messages according to a discovery protocol, and may receive data about the signal transmission path. In some embodiments, discovery module 212 may determine features, such as, but not limited to, media type, media length, number and/or type of components, data rate, modulation format of the data, input power of an optical signal, number of optical signal carrying wavelengths (e.g., channels), channel spacing, traffic demand, and/or network topology, among others.

Routing module 210 may be responsible for propagating link connectivity information to various nodes within a network, such as network 100. In particular embodiments, routing module 210 may populate database 204 with resource information to support traffic engineering, which may include link bandwidth availability. Accordingly, database 204 may be populated by routing module 210 with information usable to determine a network topology of a network.

Path computation engine 202 may be configured to use the information provided by routing module 210 to database 204 to determine transmission characteristics of the signal transmission path. The transmission characteristics of the signal transmission path may provide insight on how transmission degradation factors may affect the signal transmission path. When the network is an optical network, the transmission degradation factors may include, for example: chromatic dispersion (CD), nonlinear (NL) effects, polarization effects, such as polarization mode dispersion (PMD) and polarization dependent loss (PDL), amplified spontaneous emission (ASE) and/or others, which may affect optical signals within an optical signal transmission path. To determine the transmission characteristics of the signal transmission path, path computation engine 202 may consider the interplay between various transmission degradation factors. In various embodiments, path computation engine 202 may generate values for specific transmission degradation factors. Path computation engine 202 may further store data describing the signal transmission path in database 204.

Signaling module 206 may provide functionality associated with setting up, modifying, and tearing down end-to-end networks services in network 100. For example, when an ingress node in the optical network receives a service request, control plane 200 may employ signaling module 206 to request a network path from path computation engine 202 that may be optimized according to different criteria, such as bandwidth, cost, etc. When the desired network path is identified, signaling module 206 may then communicate with respective nodes along the network path to establish the requested network services. In different embodiments, signaling module 206 may employ a signaling protocol to propagate subsequent communication to and from nodes along the network path.

In operation, control plane 200 may be used to detect or determine nodes, links, and rings within an Ethernet network. The Ethernet network may be an existing network, such that control plane 200 communicates with network elements. In other instances, control plane 200 may process network information for a proposed network or a network design that represents a virtual network. After determination of respective numbers of the nodes, links, and rings within the Ethernet network, control plane 200 may be used to identify whether an RPL is present in the Ethernet network and/or whether multiple RPL owner nodes exist in the Ethernet network. Control plane 200 may also be used to determine whether an Ethernet network complies with the G.8032 Recommendation.

Referring back to FIG. 1, according to G.8032, a non-degenerate Ethernet ring that provides link protection includes at least two Ethernet ring nodes, such that an Ethernet ring node is linked to at least one neighboring Ethernet ring node respectively with at least two independent ring links, which provides for link protection (e.g., redundancy) when an operating link fails. The two links from a node may connect to two different adjacent nodes or two ports of the same node. The ring links are configured using RPLs to prohibit formation of logical loops that are undesirable in an Ethernet network due to uncontrollable traffic forwarding that may occur over the logical loops. The rings may be major rings (e.g., Ring 1 formed by nodes A, B, C, and D) that are configured as a physical loop with at least three nodes and at least three independent ring links. As noted previously, an Ethernet network conforming with G.8032 will have at least one major ring. The rings may also include so-called ‘sub-rings’ having at least three nodes and at least two independent ring links (e.g., Ring 2 formed by nodes B, E, F, and C).

The ring topology may be used to interconnect different Ethernet networks. For example, two Ethernet networks consisting of major rings may be interconnected using a single common node. However, such a topology is undesirable because the common node is a single point of failure for both the connected Ethernet networks, which increases risks of failure and also amplifies the impact of a failure of the common node. Under G.8032, a sub-ring (e.g., Ring 2) may be connected to a major ring (e.g., Ring 1) or another sub-ring using two common nodes, thereby enabling link protection at the two common nodes.

The RPLs are redundant links that form a physical loop but are blocked according to G.8032 to prevent a logical loop from forming. Under G.8032, the RPL may be in one of two states: idle and protecting. The idle state represents normal operation when the RPL is blocked and does not forward traffic, even though the physical link at the RPL is present. The idle state may indicate that no link or node faults are currently detected and that the network is operating normally. The protecting state represents a network condition to recover from a link error where the RPL is activated and forwards traffic. Thus, when an RPL is active, it may be assumed that another link in the network has failed. For example, the protecting state may occur during a fault of the network during a network administrator forced switch request.

In network 100, nodes A, B, C, and D may form a major ring that includes links 110-1, 110-2, 110-3, and 110-4. Link 110-4 may be configured as an RPL. The RPL may be selected or provisioned by a network administrator based on any suitable provisioning requirements. In some embodiments, the network administrator may select the RPL based on the bandwidth allocation of network 100. The RPL may be the link with the lowest bandwidth and allow the network administrator to optimize the network resources. A node connected to the RPL and blocks traffic on the RPL may be referred to as an RPL owner node. For example, in FIG. 1, node D which is adjacent to the RPL (e.g., link 110-4) may be designated as the RPL owner node. When an RPL is provisioned, all nodes of Ring 1 may unblock the ports of Ring 1 that do not correspond to the provisioned RPL.

Nodes A, B, C, and D may transmit messages indicating states of Ring 1 by using automatic production switching (APS) messages. The APS messages may use bits to indicate different states of Ring 1. For example, the APS message may have a signal fail (SF) bit to indicate a failed condition, an RPL blocked (RB) bit to indicate than an RPL is blocked, a forced switch (FS) bit to indicate that a network administrator has applied a forced switch to block a port on a node of Ring 1, and a no request (NR) bit to indicate that there are no outstanding conditions on the node. The APS message may also include unused bits.

In some embodiments, the network administrator may fail to provision an RPL. When an RPL is not provisioned, the network nodes may identify a link to block using a default process. For example, during initialization of the network, all nodes A, B, C, and D may block one port and send an APS message. When a node receives an APS message from another node with a higher node identifier (e.g., MAC address), the node may unblock its ports and stop transmitting the APS message. For example, in Ring 1, node A has the highest node identifier. Node B may block the port corresponding to link 110-2. When node B receives an APS message from node A, because node A has a higher node identifier, node B may unblock the port corresponding to link 110-2. This process may continue around Ring 1 until the only remaining blocked ports correspond to the link 110-4. While Ring 1 includes a blocked link (e.g., link 110-4), Ring 1 may stay in a pending state because an RPL has not been provisioned by a network administrator. The pending state may be the state where there is no failure in the Ethernet ring network a link is blocked, however an RPL does not exist.

Under some circumstances, a failure may occur on one link of Ring 1. For example, a failure may occur on link 110-2. When link 110-2 experiences a failure, nodes B and C may block the ports corresponding to link 110-2 and may send an APS message to the other nodes in Ring 1 indicating a signal fail (e.g., R-APS(SF)). After receiving the signal fail notification, Node A, the node with the highest node identifier, may unblock the ports corresponding to the link blocked by the default process (e.g., link 110-4) to allow Ring 1 to continue to function.

In other embodiments, a network administrator may apply a forced switch to a port on a node. For example, a network administrator may block a port on node B corresponding to link 110-2. When the network administrator blocks the port, the node may send an APS message to the other nodes in Ring 1 indicating a forced switch (e.g., R-APS(FS)). Similar to what occurs when a link fails, after receiving the forced switch notification, Node A, the node with the highest node identifier, may unblock the ports corresponding to the link blocked by the default process (e.g., link 110-4) to allow Ring 1 to continue to function.

After the failure of link 110-2 is repaired or the forced switch is cleared by the network administrator, nodes B and C may send a second APS message (e.g., R-APS(NR)) indicating that there are no outstanding conditions (e.g., failures or forced switches) at the nodes. Nodes B and C may then wait for an APS message indicating that link 110-4 has returned to its blocked state (e.g., R-APS(NR,RB)) before nodes B and C unblock the ports corresponding to link 110-2.

However, when the network administrator has failed to provision an RPL, Ring 1 may lack an RPL owner node to send a signal indicating that the link has returned to its blocked state (e.g., R-APS(NR,RB)) and nodes B and C may not unblock the ports corresponding to recovered link 110-2. This condition may result in Ring 1 remaining in a protected state, even in embodiments where Ring 1 is provisioned to work in revertive mode, and may result in Ring 1 operating less efficiently due to the use of a lower bandwidth link (e.g., link 110-4 may have a lower bandwidth than link 110-2).

Therefore, Ring 1 may include the use of an alarm to indicate the failure to provision an RPL link. The alarm may be raised if a node receives its own, previously sent APS message (e.g., node B receives the R-APS(NR) signal it sent after the failure of link 110-2 was recovered) and the node does not have any outstanding conditions (e.g., signal fail or forced switch conditions). The receipt of its own signal may indicate to a node that an RPL owner node has not been provisioned for Ring 1. After the node receives its own APS message, it may raise an alarm to indicate that a network administrator has not provisioned an RPL owner node (e.g., a FOP-RPL alarm). A network administrator may receive the alarm and may provision an RPL owner node to allow Ring 1 to function efficiently.

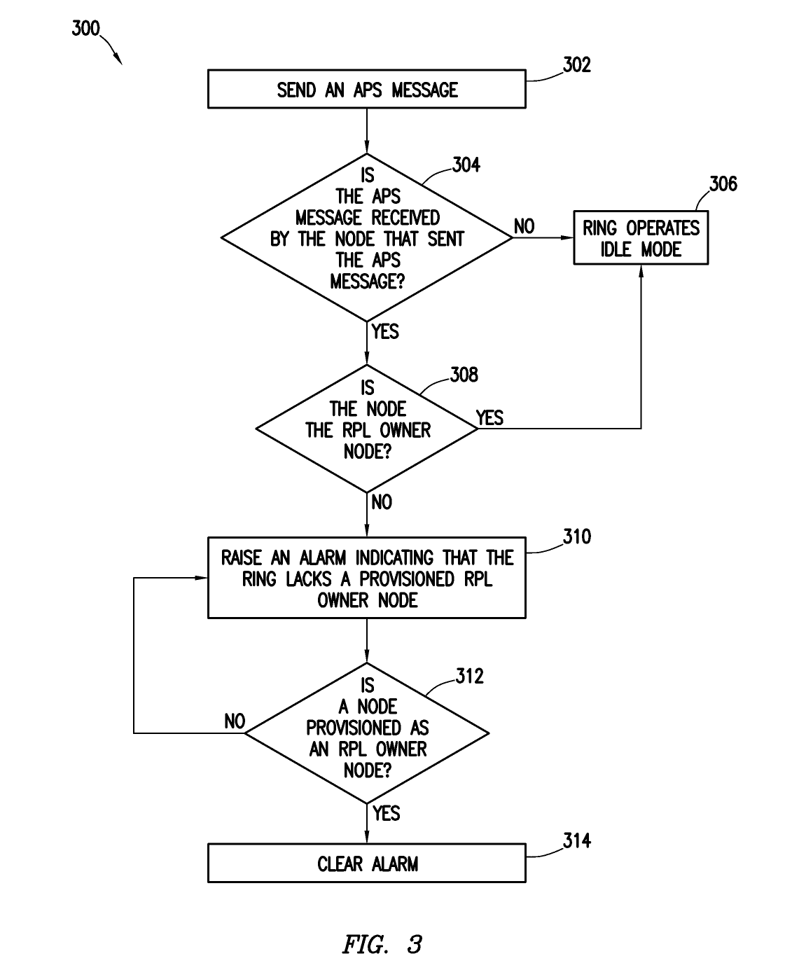

FIG. 3 illustrates a flow chart of an example method for identifying the lack of a provisioned RPL owner node in a G.8032 network ring. Some or all steps of method 300 may be performed by, or via the use of control plane 200 as described with respect to FIG. 2 for network 100 as described with respect to FIG. 1. It is noted that certain operations described in method 300 may be optional or may be rearranged in different embodiments.

Method 300 may begin with step 302 where a node of the network ring may send an APS message. The message may be sent after a link failure is repaired or after a forced switch is cleared by a network administrator. The APS message may indicate that there are no outstanding conditions at the node.

In step 304, the node may determine whether the APS message sent in step 302 is received by the node that sent the APS message. If the node that sent the APS message does not receive the APS message, an RPL owner node may be provisioned and method 300 may proceed to step 306 where the network ring may operate in an idle mode because an RPL exists. However, if the node that sent the APS message receives the APS message, method 300 may proceed to step 308.

In step 308, the node may determine whether the node is the RPL owner node. The node may detect that it is an RPL owner node based on an attribute stored in the G.8032 software logic running on the node. The attribute may be set when the node is provisioned as an RPL owner node by the network administrator. Additionally, the presence of an RPL owner node may be detected by using an APS message. The RPL blocked (RB) bit of the APS message may be set to 1 if a port on the node is blocked or 0 if the ports on the node are not blocked. Therefore, generally, for non-RPL owner nodes, the RPL blocked bit may be set to 0 and for RPL owner nodes, the RPL blocked bit may be set to 1. If the node is the RPL owner node, method 300 may proceed to step 306 where the network ring may operate in an idle mode because an RPL exists. Under normal operating conditions, an RPL owner node may receive signals sent by the node. If the node is not the RPL owner node, method 300 may proceed to step 310.

In step 310, the node may raise an alarm indicating that the ring lacks a provisioned RPL owner node. The alarm may be referred to as a FOP-RPL alarm. The network administrator may receive the alarm and may provision an RPL to allow the network ring to function efficiently.

In step 312, the node may determine if a node in the network ring is provisioned as an RPL owner node. The node may determine that an RPL owner node is provisioned based on the process described with respect to steps 304 and 308. If an RPL owner node is not provisioned, method 300 may return to step 310 and continue raising the alarm indicating the lack of a provisioned RPL owner node. If an RPL owner node is provisioned, method 300 may proceed to step 314 where the node may clear the alarm.

As discussed above, the presence of an RPL owner node may be detected by using the RPL blocked (RB) bit of the APS message where the RB bit may be set to 1 if a port on the node is blocked or 0 if the ports on the node are not blocked. Therefore, generally, for non-RPL owner nodes, the RPL blocked bit may be set to 0 and for RPL owner nodes, the RPL blocked bit may be set to 1.

However, there may be conditions where the RPL blocked bit may be set to 0 for a node that has been provisioned as an RPL owner node. For example, as required by the G.8032 Recommendation, during initialization of Ring 1, the RPL owner node may generate an APS message with the RPL blocked bit set to 0, even though the node has been provisioned as an RPL owner node. This condition may prevent other nodes from discovering the presence of the RPL owner node. Other examples of conditions where an RPL owner node may generate an APS message with the RPL blocked bit set to 0 may include cases where a condition (e.g., signal fail or forced switch) exists on Ring 1, cases where a delay timer (e.g., WTR/WTB) is running, and/or any other case where the RPL link is unblocked.

A G.8032 ring should only have one RPL owner node. However, in some instances more than one node may be designated as an RPL owner node (e.g., when a network administrator designates more than one node as an RPL owner node), resulting in duplicate RPL owner nodes. Duplicate RPL owner nodes may cause fragmentation in the ring network and Ring 1 may be designed to function with only one node provisioned as an RPL owner node. The G.8032 Recommendation includes an alarm to detect if more than one node has been provisioned as an RPL owner node (e.g., dFOP-PM alarm). However, in conditions where the RPL owner node is transmitting an APS message with the RPL blocked bit set to 0 as described previously, the alarm may not be detected due to multiple nodes of Ring 1 transmitting APS messages with the RPL blocked bit set to 0 even though those nodes may be provisioned as RPL owner nodes. Additionally, the alarm may falsely toggle (e.g., switch between alarm raised and alarm cleared) based on a toggle of a condition on Ring 1 (e.g., signal fail or forced switch). For example, the alarm may toggle based on a signal fail APS message even though a duplicate RPL owner node may not have been detected.

In conditions where a duplicate RPL owner node is detected and the alarm is appropriately raised, the alarm may not clear after the network administrator has corrected the provisioning of duplicate RPL owner nodes. Therefore, to remedy the issues with the alarm, the APS message may be modified to use a previously reserved (e.g., unused) bit as a dedicated bit that indicates the presence of an RPL owner node. The bit that indicates the presence of an RPL owner node may be used independently or in conjunction with the RPL blocked bit.

The previously reserved bit in the modified APS message may be referred to as the RPL owner (RO) bit and may be set to 1 for a node that is provisioned as an RPL owner node and set to 0 for a node that is not provisioned as an RPL owner node. At the time a node is provisioned as an RPL owner node, the node may send an APS message indicating that the node has been provisioned as an RPL owner node (e.g., an APS message with the RO bit set to 1). The APS message may be sent independent of any other condition occurring on Ring 1. The other nodes in Ring 1 may use the RPL owner bit to detect the presence of an RPL owner node on Ring 1. The nodes provisioned as RPL owner nodes may maintain a count of the number of nodes sending APS messages with the RPL owner bit set to 1. If multiple nodes send APS messages with the RPL owner bit set to 1, one or more RPL owner nodes may raise the alarm indicating that more than one node has been provisioned as an RPL owner (e.g., a dFOP-PM alarm). The alarm may be cleared when only one node is sending an APS message with the RPL owner bit set to 1.

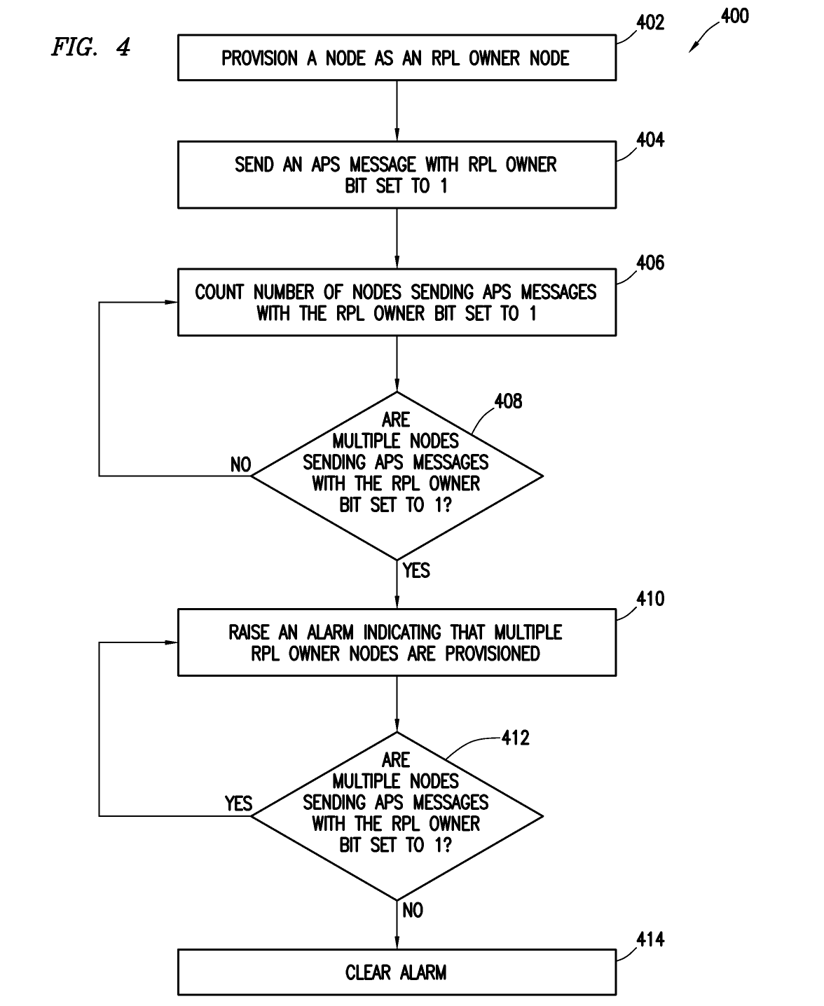

FIG. 4 illustrates a flow chart of an example method for identifying the presence of multiple RPL owner nodes in a G.8032 network ring. Some or all steps of method 400 may be performed by, or via the use of control plane 200 as described with respect to FIG. 2 for network 100 as described with respect to FIG. 1. It is noted that certain operations described in method 400 may be optional or may be rearranged in different embodiments.

Method 400 may begin with step 402 where a network administrator may provision a node of a G.8032 network ring as an RPL owner node. The RPL owner node may block a port of the node to provide an RPL for the network ring. The network administrator may provision any node of the network ring as the RPL owner node. In some embodiments, the network administrator may be select a link with the lowest bandwidth and provision a node connected to that link as the RPL owner node in order to optimize the bandwidth allocation of the network.

In step 404, the RPL owner node may send an APS message where an RPL owner bit of the APS message is set to 1. The APS message may be sent independent of any other condition occurring on the network ring. The other nodes in the network ring may use the RPL owner bit to detect the presence of an RPL owner node on the network ring.

In step 406, the RPL owner node may count the number of nodes sending APS messages where the RPL owner bit of the message is set to 1. The count may be based on the RPL owner bit and the unique node identifier (e.g., MAC address) of the node sending the APS message.

In step 408, the RPL owner node may determine whether multiple nodes are sending APS messages with the RPL owner bit set to 1 based on the count performed in step 406. If the RPL owner node determines that no more than one node is sending an APS message with the RPL owner bit set to 1, method 400 may return to step 406, where the RPL owner node may continue to monitor the number of nodes sending APS messages with the RPL owner bit set to 1. If the RPL owner node determines that multiple nodes are sending APS messages with the RPL owner bit set to 1, method 400 may proceed to step 410.

In step 410, the RPL owner node may raise an alarm to alert the network administrator that multiple RPL owner nodes have been provisioned. Duplicate RPL owner nodes may cause fragmentation in the network ring and the network ring may be designed to function with only one node provisioned as an RPL owner node. The alarm may be referred to as a dFOP-PM alarm, as defined in the G.8032 standard.

In step 412, the RPL owner node may determine whether multiple nodes are sending APS messages with the RPL owner bit set to 1 based on the count performed in step 406. If the RPL owner node determines that multiple nodes are sending APS messages with the RPL owner bit set to 1, method 400 may return to step 410 and continue raising the alarm. If the RPL owner node determines that multiple nodes are not sending APS messages with the RPL owner bit set to 1, method 400 may proceed to step 414, where the RPL owner node may clear the alarm. The alarm may be cleared after the network administrator corrects the provisioning of multiple RPL owner nodes.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for identifying a ring protection link (RPL) owner node in an Ethernet network, comprising:
sending, by a node in a ring of an Ethernet network having a plurality of nodes and an RPL, an automatic protection switching (APS) message;
receiving, by the node via the ring, the APS message;
determining whether the node is an RPL owner node that controls the flow of traffic on the RPL; and
raising, when it is determined that the node is not an RPL owner node, an alarm indicating that the ring lacks a provisioned RPL owner node.

2. The method of claim 1, further comprising:
provisioning, when it is determined that the node is not an RPL owner node, one of a plurality of nodes as the RPL owner node; and
clearing the alarm.

3. The method of claim 1, wherein the APS message is sent after a link failure is repaired.

4. The method of claim 1, wherein the APS message is sent after a forced switch is cleared.

5. The method of claim 1, wherein the APS message indicates that there are no outstanding conditions on the ring.

6. A method for identifying a ring protection link (RPL) owner node in an Ethernet network, comprising:
provisioning one of a plurality of nodes as an RPL owner node;
sending, by the RPL owner node, an APS message with an RPL owner bit set to 1;
counting a number of nodes sending APS messages with the RPL owner bit set to 1;
determining whether the number of nodes sending APS messages with the RPL owner bit set to 1 is greater than one; and
raising, when it is determined that the number of nodes sending APS messages with the RPL owner bit set to 1 is greater than 1, an alarm indicating that multiple RPL owner nodes are provisioned.

7. The method of claim 6, further comprising:
determining whether the number of nodes sending APS messages with the RPL owner bit set to 1 is equal to one; and
clearing the alarm.

8. The method of claim 6, wherein counting the number of nodes sending APS messages with the RPL owner bit set to 1 is based on the RPL owner bit and a unique node identifier.

9. The method of claim 6, wherein the APS message is sent independently of a condition on the ring, the condition including at least one of a signal fail condition, an RPL blocked condition, and a forced switch condition.

10. The method of claim 6, wherein the RPL owner bit is a previously reserved bit of the APS message.

11. A system for identifying logical loops in an Ethernet network, comprising:
a processor configured to access non-transitory computer readable memory media, wherein the memory media store processor-executable instructions, the instructions, when executed by a processor, cause the processor to:
send, by a node in a ring of an Ethernet network having a plurality of nodes and an RPL, an automatic protection switching (APS) message;
receive, by the node via the ring, the APS message;
determine whether the node is an RPL owner node that controls the flow of traffic on the RPL; and
raise, when it is determined that the node is not an RPL owner node, an alarm indicating that the ring lacks a provisioned RPL owner node.

12. The system of claim 8, the instructions further cause the processor to:
provision one of a plurality of nodes as an RPL owner node; and
clear the alarm.

13. The system of claim 11, wherein the APS message is sent after a link failure is repaired.

14. The system of claim 11, wherein the APS message is sent after a forced switch is cleared.

15. The system of claim 11, wherein the APS message indicates that there are no outstanding conditions on the ring.

16. A system for identifying logical loops in an Ethernet network, comprising:
a processor configured to access non-transitory computer readable memory media, wherein the memory media store processor-executable instructions, the instructions, when executed by a processor, cause the processor to:
provision one of a plurality of nodes as an RPL owner node;
send, by the RPL owner node, an APS message with an RPL owner bit set to 1;
count a number of nodes sending APS messages with the RPL owner bit set to 1;
determine whether the number of nodes sending APS messages with the RPL owner bit set to 1 is greater than one; and
raise, when it is determined that the number of nodes sending APS messages with the RPL owner bit set to 1 is greater than 1, an alarm indicating that multiple RPL owner nodes are provisioned.

17. The system of claim 16, the instructions further cause the processor to:
determine whether the number of nodes sending APS messages with the RPL owner bit set to 1 is equal to one; and
clear the alarm.

18. The system of claim 16, wherein counting the number of nodes sending APS messages with the RPL owner bit set to 1 is based on the RPL owner bit and a unique node identifier.

19. The system of claim 16, wherein the APS message is sent independently of a condition on the ring, the condition including at least one of a signal fail condition, an RPL blocked condition, and a forced switch condition.

20. The method of claim 16, wherein the RPL owner bit is a previously reserved bit of the APS message.
